(19) United States
(12) Patent Application Publication
(10) Pub. No.: US 2025/0223712 A1
(43) Pub. Date: Jul. 10, 2025

(54) NTAC -Driven Electrodes for Photo-Enhanced Electro-Catalytic (PEEC) Processes

(71) Applicants: Sang H. Choi, Poquoson, VA (US); Robert W. Moses, Poquoson, VA (US)

(72) Inventors: Sang H. Choi, Poquoson, VA (US); Robert W. Moses, Poquoson, VA (US)

(21) Appl. No.: 19/072,330

(22) Filed: Mar. 6, 2025

Related U.S. Application Data
(60) Provisional application No. 63/617,873, filed on Jan. 5, 2024.

(51) Int. Cl. C25B 9/50; G21G 4/04

(52) U.S. Cl. CPC C25B 9/50; G21G 4/04

(57) ABSTRACT

Means and method for photo-enhanced electro-catalytic process using nuclear thermal NTAC-integrated PEEC (PEEC-NTAC) catalytic processes combining ECM with energetic photon sources, such gamma rays, and sono-catalytic driver.

This application claims the benefit of the filing date of U.S. Provisional Patent Application No. 63/617,873 filed on Jan. 1, 2024.

### BACKGROUND

The platinum group metals (PGM) family has been used as catalytic agents. This group of metals consists of the densest known metals and comprises six transitional metal elements that, structurally and chemically, are very similar. Since the PGMs have high durability and longer lifecycles in chemical processes, PGMs are used for a variety of demanding applications. PGMs are good automotive emission control catalysts because they are useful in catalyzing NO to nitrogen and in oxidizing carbon monoxide (CO) and hydrocarbons, HC. The International Platinum Group Metals Association (IPA) estimates that catalytic converters fitted inside a car exhaust pipe can convert more than 90 percent of HC, CO and NO from an engine combustion process into less harmful carbon dioxide (CO2), nitrogen and water vapor. But these PGM metals are in short supply and expensive. Although platinum has several advantages over other metals in terms of its high melting point, alternate options are continuously sought for variety of applications.

Catalytic agents are critical in a variety of applications in order to reduce the activation barrier (overpotential barrier) in electrochemical reactions. The dissociation of a water molecule into hydrogen and oxygen requires a bipolar catalytic medium to lower the activation energy barrier from 5.15 eV to the lowest possible level per H—OH bond. The water dissociation rate mainly depends on the efficiency of junctional catalysts. Conventionally defined highly effective catalysts are required to minimize the overpotentials for oxygen evolution reaction (OER) and hydrogen evolution reaction (HER) towards efficient H2 and 02 production.

Better performing catalytic materials, no matter whether they can work on catalytic process directly or electro-assisted or photo-assisted way, are still in great demand for many applications. The invention disclosed herein provides for a new self-powered electrode approach designed for better catalytic effect to answer to various demands without regard to the conventional issues of overpotential barrier while lowering kinetic barrier.

### A.—General Description of Problem/Objective

A way to breakdown aqueous or gaseous molecules into environmentally friendly or demand-oriented useful components requires high energy with or without using catalysis. For example, breakdown of carbon dioxide in general is very much desirable but a low-cost approach has yet to be developed. The problems associated with carbon dioxide, especially impact to the atmospheric balance for modest environmental fluctuation, justifies the development of various breakdown technologies of carbon dioxide. Hydrogen is regarded as a potential new green energy source but the costs of production and distribution of hydrogen have limited the development of hydrogen as a green energy source.

Currently-known catalytic materials and their processes are not only greatly ineffective in performance, but also costly and therefore have not seen wide adoption.

The present invention provides numerous advantages over currently known catalytic materials:
1) The PEEC-NTAC based nano-structured ECM can flexibly use of any inexpensive transition metals as electrode materials.
2) The rate of dissociation with any inexpensive transition metals can exceed any level of dissociation rate so far known with the PGM.
3) The ECM with high energy photon sources, such as gamma rays, is applicable to most of chemical synthesis and dissociation processes.
4) The interaction of nano-scale ECM with energetic photons drastically increases surface energy of nano-scale ECM by the increase in population density of liberated free electrons (or charge potential) at the surface of nano-structure ECM that alleviates or diminishes the overpotential issue often happened over the conventional electrocatalytic processes.
5) Artificially enhance charge potential due to the high population density of liberated free electrons through interaction of ECM with energetic photons suppresses thermodynamic potential (1.23 V) and intrinsic kinetic barrier potential (5.15 V) for faster electrocatalytic reaction kinetics by/j_V in FIG. 12.
6) Artificially enhance charge potential due to the high population density of liberated free electrons through interaction of ECM with energetic photons increases the exchange current density which lowers reaction barrier.
7) High exchange current density enhances charge transfer rate by even over the required charge density to nearly diminish and nullify the overpotential issues at HER and/or OER.
8) Energetic photons can directly couple with water molecules that leads to break down water molecules under the radiolysis process.
9) Since energetic photons can penetrate deep in ECM by long mean free path, a thick nano-structured ECM can be used for anode and cathode. Thick ECM with increased volume and reaction surface area can drastically increase the production rate of hydrogen and oxygen.
10) The invented PEEC-NTAC can use any well-proven electrocatalytic materials or extend its own use of ECM with untested metals and alloys without regard to a specific surface energy required for electrocatalytic process.
11) The NTAC integrated to PEEC can generate sufficient power needed for PEEC operation.
12) The PEEC-NTAC system uses a sono-catalytic driver to keep the nano-structured ECM clean and refreshed in real time.
13) The frequency coupling, known as Bragg scattering, between the acoustic wave of sono-catalytic driver and the resonant frequency of nano-structured ECM creates a Bragg field energy which perturbs the medium in the vicinity of ECM. The perturbation of medium increases oscillatory collision of molecules to the surface of nano-scale structure of ECM that will increase the rate of catalytic reaction.
14) The excessive driving power by the sono-catalytic driver can cause not only a cavitation effect on the surface of nano-scale structure of ECM, but also sono-power-initiated catalytic reaction.
15) A single cell unit or a multi-cell unit that comprises of a cathode and an anode as a pair of NTAC-integrated PEEC electrodes.
16) The system requires an additional blanket of radiation shielding wrapped around the system.

The currently disclosed invention, the NTAC-integrated PEEC (PEEC-NTAC) gives extraordinary catalytic processes because of a combination of ECM with energetic photon sources, such gamma rays, and sono-catalytic driver. The combined effects on catalytic process are seen by the facts of very high potential field within and in the vicinity of nano-scale structure of ECM for accelerated catalytic reaction, the radiolysis effect by high energy photons, and the Bragg field energy that can drastically increase the dissociation rate. The NTAC alone provides power needed for all this processes without any external power feed.

The PEEC-NTAC system can utilize a choice of inexpensive transition metals as electro-catalytic media since energetic photons induce high population density of liberated free electrons beyond the conventional concepts that rely on noble metals and noble metal oxides. The PEEC-NTAC exceeds the conventional catalytic processes by overcoming the thermodynamic potential and intrinsic kinetic barrier potential for faster electrocatalytic reaction. The integrated dissociation or synthetic process of aqueous and gaseous molecules that will offer the production of oxygen, hydrogen, water, methane or many more chemicals as the end-products is unique.

The invention as disclosed herein provides other numerous advantages over the prior art. The invention can reduce the environmentally unwanted gas, carbon dioxides, and at the same time it can produce useful chemicals, oxygen, hydrogen, water, methane, and even further polymers in a single integrated system. Further advantages includes:
1) With the gamma rays based NTAC, the ECM can flexibly use of any inexpensive transition metals.
2) The rate of dissociation with any inexpensive transition metals can exceed any level of Faradaic efficiency.
3) The ECM with gamma rays can be applicable to most of chemical synthesis and dissociation processes.
4) No external power required.
5) A combination of high energy photons and sono-catalytic driver provides additionally radiolysis and sono-catalysis.

Additionally, the invention as described herein provides numerous potential areas of use and/or application, such as:

The future of space exploration requires onsite propellant production to make long distance trips to planetary and other solar system bodies viable. This invention will greatly help the production of oxygen, hydrogen, methane, and polymers in a single integrated system approach. The present invention can also be utilized for the production of oxygen and hydrogen from ice water harvested from permanently shadowed region of the Moon.

The present invention further provides improvements in terrestrial application and industries such as:
The reduction of environmentally polluting and global warming gas, CO2.
Enhanced scrubber technology to get rid of CO2 at flue stacks of factories.
Enhanced chemical processes of dissociation and synthesis in an inexpensive way.
Enhanced hydrogen production.

### BRIEF DESCRIPTION OF THE DRAWINGS

FIG. 1 shows the cross-section of AN electrode integrated with three NTAC layers in accordance with an embodiment of the present invention.

FIG. 2 shows a catalytic electrode with a positive polarity built over an insulator layer that shields electrons collected by the collector from crossing into the catalytic electrode in accordance with an embodiment of the present invention.

FIG. 3 shows a catalytic electrode with a negative polarity built over an insulator layer that shields electrons collected by the collector from crossing into the catalytic electrode in accordance with an embodiment of the present invention.

FIG. 4 shows a pair structure of PEEC in accordance with an embodiment of the present invention.

FIGS. 5(a)-(b) shows charge density electrostatic potential fields in accordance with an embodiment of the present invention.

FIG. 6 shows an energy diagram for electro-catalyst in accordance with an embodiment of the present invention.

FIG. 7 shows incident photons coupling with atoms and porous structures in accordance with an embodiment of the present invention.

FIG. 8 depicts the penetration depth of gamma ray, X-ray, and soft X-rays through the ECM in accordance with an embodiment of the present invention.

FIG. 9 shows the nano-structured porous foamy electro-catalytic medium (ECM) that encapsulates the NTAC as photon sources in the middle in accordance with an embodiment of the present invention.

FIG. 10 shows a conceptual description of a NTAC-integrated PEEC reactor chamber model in accordance with an embodiment of the present invention.

FIG. 11 shows a multi-cell NTAC-integrated PEEC reactor in accordance with an embodiment of the present invention.

FIG. 12 shows shifts in current density in a NTAC-integrated PEEC reactor in accordance with an embodiment of the present invention.

### DETAILED DESCRIPTION OF THE INVENTION

Most conventional catalytic processes rely upon expensive catalytic materials, such as platinum group metals (PGM) family, and consume a huge amount of power to disintegrate or dissociate chemical materials. Accordingly, in order to reduce or alleviate a huge power requirement and at the same time to increase the dissociation or synthesis rate of chemicals, most progress in the art has been focused on the identification and development of new and inexpensive catalytic materials. However, the current efforts keep pushing the limit on functional performance of catalytic materials including topologic layout of catalytic electrodes.

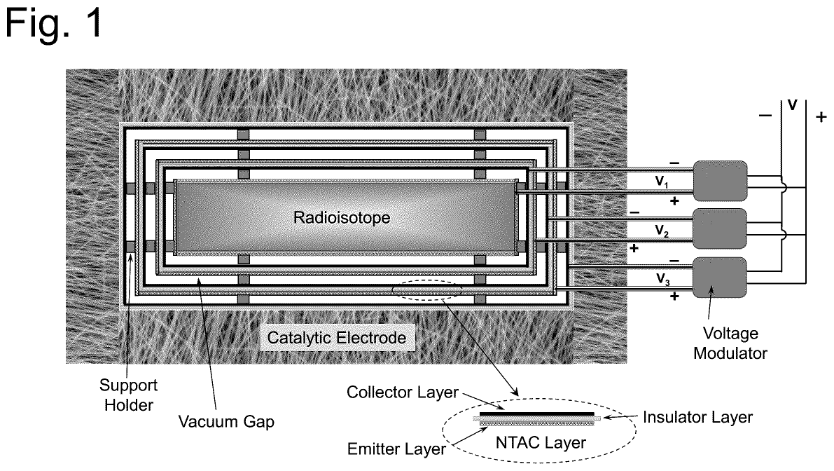

The present invention teaches several different new configurations of electrodes for Photo-Enhanced Electro-Catalytic (PEEC) reactions. The electrodes are integrated with a nuclear thermionic avalanche cell (NTAC) for both roles of the self-sustained power generation needed for the operation of PEEC and the enhancement of catalytic reactivity. FIG. 1 shows the cross-section of one of electrodes integrated with three NTAC layers. The radioisotope of electrode is wrapped around by an emitter layer on where the gamma ray photons and/or energetic beta particles from radioisotope impinge. The emitter material under the impingement of gamma ray photons and/or energetic beta particles undergoes coupling interactions with gamma ray photons and/or beta particles which are well-known physical phenomena defined as photo-electric, Compton scattering, photo-nuclear under unstable resonant mode, and positron-electron pair production. Through these coupling interactions, those electrons resided in intra-band of atoms, including electrons in the outermost shell, are liberated, and released into the vacuum gap. The motion of these large number of electrons into the vacuum gap poises like the avalanche of electrons that are eventually collected by the collector which is located across the vacuum gap. The NTAC layer consists of a collector, an insulator, and an emitter as a single combined layer.

Since the energies of gamma ray photons and beta particles are high enough that the primary, secondary, tertiary, and higher order interactions through the first NTAC layer would not be used up, the unused energies of incident gamma ray photons and beta particles are transmitted through and arrive at the next NTAC layer. Even through the high order interactions, their energies contribute to a high-rate liberation of electrons from intra-bands of atoms through a process of bound-to-free and free-to-free transitions. These liberated electrons mostly appear as free electrons ejecting out from the emitter surface. Some of the remnants of energies are continuously transmitted through a NTAC layer. Some portion of the energies is used up for the emission of induced radiation, Bremsstrahlung, and Auger electrons through high order interactions. Therefore, the use-up of whole radiation energy requires several NTAC layers where the radiation energy can be exhausted while passing through the number of NTAC layers. Meanwhile, a bunch of liberated electrons across the vacuum gap is channeled into power circuitry.

The NTAC integrated into the PEEC electrode is designed to use roughly 60%˜70% of radiation energy. The rest (30%˜40%) will be used to energize the nano-structured catalytic material of PEEC. Accordingly, for the application of NTAC for PEEC, only a fewer number of NTAC layers are integrated within the PEEC electrodes to generate electrical power without using up the radiation energy. The rest of radiation energy is directly used up to further energize the nano-structured electrode material in addition to the electrical charge applied by the power from the integrated NTAC layers. When the rest of radiation energy that is transmitted through NTAC layers eventually impinges on electrode material, scattering interactions take place through the nano-structured electrode material. Likewise, the avalanche electrons liberated from the intra-band of atoms within electrode material behave like the D-orbital electrons by keeping a high probability of excited state that results in the increase in the surface energy. These excited or liberated electrons just behave like the D-block electrons in platinum group metals (PGM).

Since the PGMs have a D-orbital electron structure which allows quantum inter-transition, the inter-transition of D-orbital generally appears as increased field potential on the surface of their atoms. Accordingly, the surface energy of D-orbital materials is generally high that D-orbital materials attract and energize the other molecules in a temporary sticking or in a proximity. When other molecules stick or are in proximity, the state of surface energy with free charge of overall electron cloud is changed and undergoes a transition along with unstable resonant mode of domain energy or domain potential and eventually to the local minimum level of magnitude of surface energy which in turn allows the stuck molecules or molecules in the vicinity to get their bonding structure stressed and rearranged or dissociated into new compounds or vice versa. The catalyst itself does not change. The rearranged or dissociated molecules are eventually drifted away or pushed out by new input ones (temperature and/or field caused motion) to continue the cycle of process unless the conditions are changed.

Surface free energy is a measure of the excess energy present at the surface of a material, in comparison to at its bulk. In the bulk form of a material, atoms in the middle are generally stable and have a balanced set of bonds/interactions. In contrast, the surface atoms will have an incomplete, unbalanced set of interactions, and therefore have unrealized bonding energy, as mentioned above, with PGM which have the effect of D-orbital structure appeared at their surface. ‘Surface energy’ is a relative measurement of the energy at the surface (which is a result of this incomplete bonding by inter-transition). A surface always tries to minimize its energy. This can be done by adsorbing a material with a lower energy onto its surface. Through the adsorption process, the number of exposed surface atoms with high surface energy are minimized and replaced with lower energy atoms or molecules. Therefore, a porous and foamy structure of catalyst is more effective because of the large areas of exposed surface which demonstrates high surface energy. When a porous and foamy structure or nano-structured electrode material is exposed to high energy radiation, those avalanche electrons liberated from the intra-band of atoms behave like the D-orbital electrons of PGM. Therefore, the surface energy of nano-structured electrodes is already high by the extended exposure of D-orbital electrons under the nano-scale dimension of domain but further increased by keeping a high probability of excited state of those excited electrons under a bound-to-free transition within the atoms of nano-structured electrode.

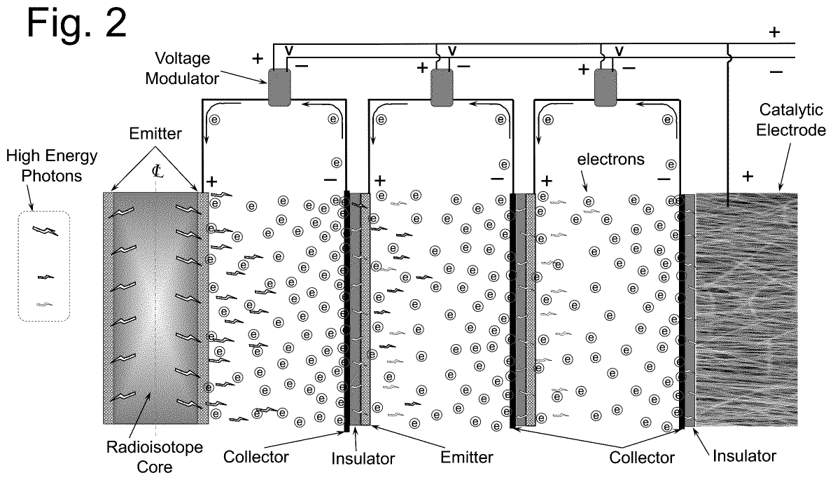

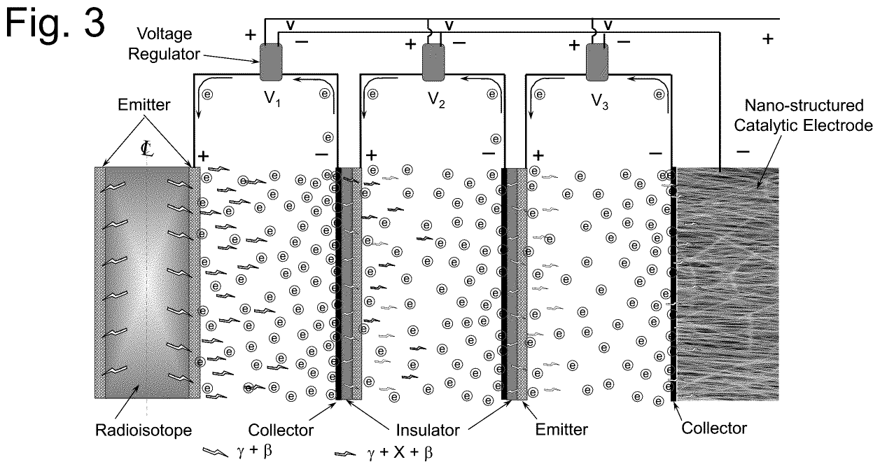

The catalytic electrode shown in FIG. 2 is built over an insulator layer that shields electrons collected by the collector from crossing into the catalytic electrode. Because of the charge collected at the collector, the layer of a collector-insulator-catalytic electrode forms electrically a capacitive structure. In this capacitor formation, the catalytic electrode builds relatively a positive charge which is beneficial for setting a positive polarity. On the other hand, FIG. 2 shows an opposite case for setting a negative polarity. The only difference between FIGS. 2 and 3 is the polarity of catalytic electrodes. The catalytic electrode shown in FIG. 2 has a positive while FIG. 3 with a negative polarity. To keep the negative polarity of catalytic electrode, an insulator layer which is located between the collector and the catalytic electrode is removed for those collected electrons to negatively influence the catalytic electrode as shown in FIG. 3. In either case, the transmission of the remainder of radiation through the last layer of NTAC, whether the insulator is there at the last NTAC layer or not, is not hampered at all. As mentioned earlier, the radiation that impinges on catalytic electrode material, even though weakened, interacts further with catalytic electrode material (CEM). Once bombarded by radiation, the CEM stays on an excited state by the increased number of liberated electrons that raises its own potential drastically.

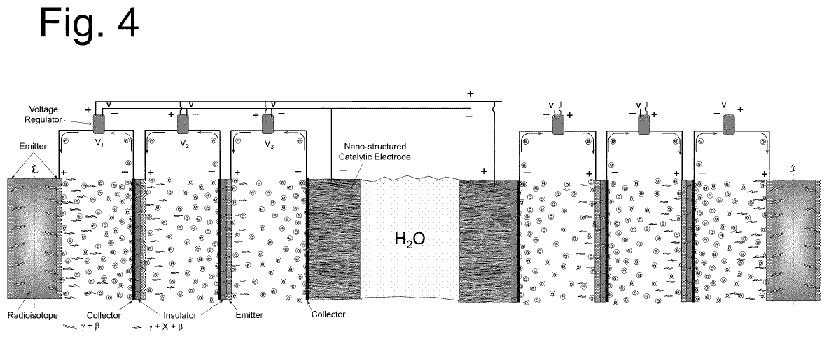

A set of catalytic electrodes shown in FIGS. 2 and 3 forms a pair structure of PEEC as shown in FIG. 4.

As shown in FIGS. 2 and 3, on each NTAC layer, those collected electrons are modulated to yield a uniform voltage which is fed to catalytic electrode materials to develop a disparity of charge potential. Generally, the catalytic effect by surface energy is positively correlated to four different physical phenomenal aspects: (1) the strength of catalytic interactions is related to materials, (2) the level of increased surface exposure area widens more potential field energy by D-orbital electrons, (3) the stress associated with non-negligible polarity develops in magnitude, and (4) even the perturbed potential field in minimum energy increases the interaction rate. In general, surface energy of catalytic materials becomes higher when the bulk interactions are stronger by the population of D-orbital electrons or the area of surface exposure per volume is greater, or the localized polarization field exists, or the localized perturbation of potential field exists with the minimum energy of carrier mobility.

Radiolysis Effect: One of the additive anticipations with the use of radiation for NTAC is the radiolysis effect. The NTAC integrated into the PEEC electrode is designed to use roughly 60%˜70% of radiation energy. The rest (30%˜40%) will be used to energize the nano-structured catalytic material of PEEC. While energizing the foamy porous or metal wire sponge like nano-structured PEEC catalytic material, this electrode material gets wet and soaked with infiltrated water. Some molecules of water engage coupling directly with high energy photons. In this case, the radiolysis of water is observed and results in the production of electrons, H atoms, OH radicals, H3O+ ions and molecules like H2 and hydrogen peroxide (H2O2). Direct coupling of water molecules with high energy photons that come out of NTAC leads the breakdown of water molecules into hydrogens and H radicals. However, the rate of breakdown is dependent on the absorption cross-section of water molecules for the intensity and flux of impinging photons.

Sono-catalytic Process: Bragg Energy Effect by Resonance: The surface of nano-structured catalytic material builds up a sludge over a long operation. This surface contamination can be, on real-time basis, removed by applying intensive high frequency ultrasound.

When a high frequency of acoustic wave is injected, the wave energy couples with the resonant mode of material's natural frequency if both matches. A tiny embodiment of nano-structure catalytic material can be easily coupled with a high frequency of acoustic wave because the natural resonant frequency of a nano-scale body of material is high and can be entangled and coupled with the incident high frequency acoustic wave. In such a case, the resulting coupled form of the frequency of incident acoustic wave and the resonant frequency of nano-structured catalytic materials causes a kind of Bragg scattering. Therefore, the surface cleaning can be done by this Bragg scattering. If the intensity of Bragg effect increases, the Bragg energy can not only physically remove the surface contaminants, refresh and energize the electrode surface and increase the molecular collision frequency on electrode surface due largely to the Bragg energy that increases kinetic energy of water molecules, but also even lead to molecular breakdown and cavitation. When the wave energy is high, the phenomena of such molecular breakdown and cavitation are designated as sono-catalysis since the Bragg energy even attributes and enhances the chemical reaction.

The combination of sonochemistry with catalysis can be used to accomplish a number of chemical reactions with convenient workup conditions (e.g. shorter reaction times) in contrast to more conventional methods [4]. Heterogeneous reactions follow via ionic intermediates provoked by mechanical effects, whereas radical reaction enhanced mainly by sonication. In the case when radical and ionic mechanisms lead to other products, ultrasound might promote the radical reaction, which can also provide new synthetic pathways [5]. The fundamental rule of sonocatalysis is diffusion and sorption of the main components on a solid surface followed by a series of heterogeneous chemical reactions on active sites [6]. In a heterogeneous reaction system, the improvement of chemical reaction is mainly caused by physical effects. The physical phenomena improve mass transfer from turbulent mixing and acoustic streaming, generate cavitation erosion at liquid-solid interfaces, and are responsible for deformation of solid surfaces [7].

The effect of ultrasonic irradiation on a heterogeneous catalyst may cause physical and chemical modifications (e.g. changes in crystallization, dispersion, and surface properties, as well as changes on catalytic reactivity during reaction [8]. The chemical rate increases due to enhancement of external transport phenomena and the increase in temperature at the catalyst surface. Acoustic cavitation can induce the breaking of the catalytic particle and gives more accessibility to the internal surface for the reagents. In the gas-liquid-solid system (e.g. hydrogenation reactions) sonication increases the interphase surface and favors the removal of outer oxide or other passivating layers from the catalyst surface [9].

Accordingly, the invented idea of PEEC electrode integrated with NTAC has clear advantages over the PGM or other catalytic material technologies because of:
(1) the strength of catalytic interactions is no longer tied up with the selection of materials, such as PGMs;
(2) the high probability and sustainability of excited state that are attributed to a large population of liberated electrons through continuous high order interactions with high energy photons;
(3) the increased chemical stress associated with the strength of potential field energy;
(4) the increased chemical stress associated with the direct coupling of incident radiation which is called radiolysis process;
(5) the nano-scale domains of catalytic electrode materials that requires a local minimum in field energy;
6) the perturbed field energy associated with nano-scale domain structures that increases the rate of catalytic activity;
(7) the compound effect on catalytic reaction rate by the nano-scale domains of catalytic electrode materials and the high probability and sustainability of excited state by continuous incident radiation;
(8) the sono-catalytic effects that is primarily used for cleaning and refreshing nano-structured electrode by high frequency acoustic wave;
(9) the reaction field perturbation by the Bragg energy effect resulted from two wave couplings between the frequency of acoustic wave and the natural resonant frequency of nano-scale electrode materials;
(10) Almost maintenance service free due to the self-sustained power and self-refreshing capability;
(11) not only the enhanced catalytic process, but the electrical power by NTAC outpaces over any other advantages that keeps the operation continuously without refueling or outside power feed.

The catalytic effect by the stress field of charge potential is correlated to the non-negligible polarity in which a foreign substance gets an experience with severe bodily strain under the influence of charge potential. If the stress energy caused by the non-negligible polarity exceeds the bonding energy of foreign substances, the dissociation of foreign substance will be an inevitable consequence. The stress field is directly related to the field gradient of charge density. It is already discussed that a sharp edge or nano-scale entities keep high surface energy due to the fact of densely exposed D-orbital electron structure that attracts and adsorbs and drives neighboring molecules to be loosely relaxed in bonding structure by sharing the surface energy.

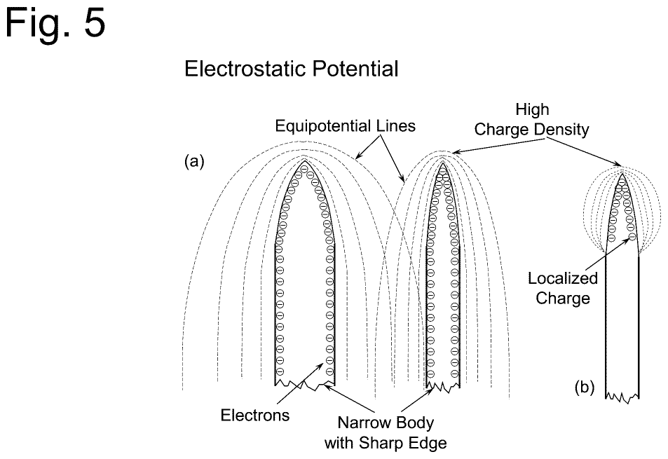

Although the mechanism of surface energy for catalytic effect is not quite clearly understood yet, the D-orbital block of PGM is well-proven and widely accepted as good catalytic agents. Here what is known at this point is the surface energy that has a key role for a catalyst and is regarded as a virtual energy since it can be created by either the constrained geometries, such as sharpness of edges and tiny configured nano-scale bodies. Or the surface energy of sharp edges can be increased by the disparity in potential field formed by the charge density as shown in FIG. 5. The charge polarity may be the case caused between two fields with different magnitude or by the geometrically determined domain charge distribution or singly created a strong field density by the localized charge density at the tip of sharp edge as shown in FIG. 5b. The potential field density profiles around two different sizes of narrow bodies are shown in FIG. 5(a). If any entity is located within this field gradient, it will experience a virtual stress that is created between the size-dependent field density gradients (FIG. 5a) or at the areas, usually a sharp edge where the field density is high (FIG. 5b).

It is now quite clear that the stress energy related to the surface energy can be enhanced for improved catalytic effect by applying the electric potential to the narrow body with sharp edges [10].

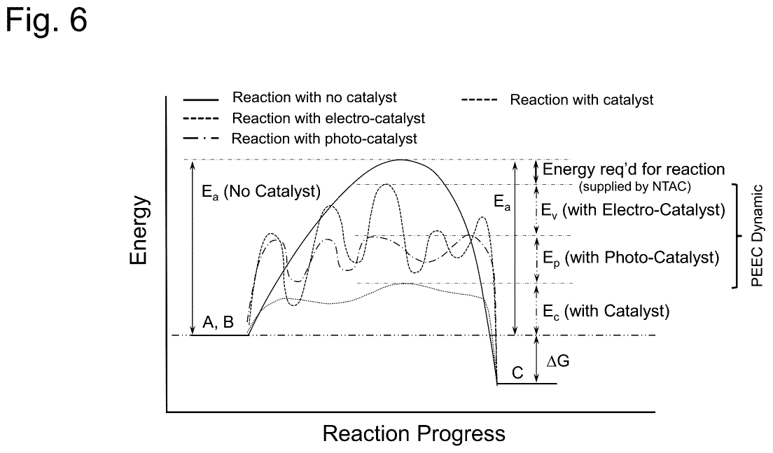

The energy diagram for electro-catalyst shows fascinatingly a lowered energy requirement by the amount of Ee−Ev further from the energy (Ee) required with catalyst as an apparent benefit, as shown in FIG. 6. Here a photo-catalyst (EP) is regarded as an alternate method to replace the plasma chemical process and as an additional catalytic processing scheme on top of the micro- or nano-structured catalyst (EC) and electro-catalyst (EV) as described in FIG. 6.

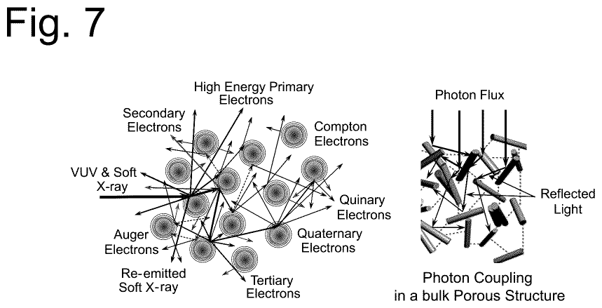

Based on the energy requirement for dissociation process, it is well-known that the electro-catalytic method enhances the breakdown rate of gaseous and aqueous molecules. However, as discussed above, the photo-catalytic process (EP) adds substantial advantages over any existing methods to reduce the required energy of chemical process. FIG. 7 shows how incident photons couple with atoms and porous structure. If the energetic photons, such as X-ray and gamma ray, are impinged on the materials, the dominant coupling mechanism of energetic photons will be with the inner shell electrons and also with nucleus of atom as depicted in the left-hand side of FIG. 7. Otherwise, the photon coupling in a bulk porous structure can be described as shown in the right of FIG. 7. The energy of incident photon flux is partially absorbed by porous material like nano-scale structure and the rest is reflected, trapped into porous space, and eventually absorbed into material as shown in the right of FIG. 7. The absorbed photon energy can have partially a thermal effect to raise the temperature of material that in turn thermalize electrons. The rest has a direct effect on the level transitions of the electrons of atom through the bound-to-bound and/or bound-to-free transitions. The excited electrons that underwent bound-to-bound transitions by photon couplings eventually go down to their ground state while remitting the equivalent energy of excitation. For a coupling with the incident energetic photons, the excessive photon energy causes a bound-to-free transition of electrons that liberates electrons free. Therefore, the photo-agitated electron emission itself from electro-catalyst can not only increase the charge potential in the vicinity of nano-scale structure that is additive to the surface energy of electro-catalyst, but also dynamically disturbed field by the emitted free electrons causes molecules to behave under the unstable resonant mobility with dynamic field perturbation. The dynamic field perturbation increases the collision frequency of not only among molecules, but also between molecules and electro-catalyst. Both accelerate the energy sharing in equilibrium that might be another additive to the catalytic process.

Radioisotopes: The PEEC integrated with NTAC requires gamma ray source, such as cesium-137 (Cs-137) which emits 661 keV photons [11], in the middle of electro-catalytic material.

Table I shows a tabulation of photon sources that is applicable to the invented NTAC-integrated PEEC device. Radioisotopes, Cs-137 and Co-60, offer very attractive features for not only long-term operation, but also high energy photons to excite and liberate the intra-band electrons of atoms in catalytic medium which will exceed the dissociation energy of aqueous or gaseous molecules.

TABLE I
Photon Sources for PEEC Applications

| [symbol] s | vuv | | | X-Ray | | Gamma Ray | | | |
|---|---|---|---|---|---|---|---|---|---|
| Conventional | FUV | EUV | | Soft | Hard | Cs-137 | | Co-60 | |
| Name | | | | X-ray | X-ray | | | | |
| Energy | 6~30 eV | 30~700 | eV | 700 eV~ | 3 keV ~ | 600 | keV | 1.3325 | MeV |
| | | | | 3 eV | 100 keV | | | | |
| Spectral | 200~40 nm | 40~2 | nm | 2~0.4 nm | 0.4~0.012 nm | 0.00188 | nm | 0.00093 | nm |

| | | | | | | |
|---|---|---|---|---|---|---|
| Range | | | | | | |
| | [symbol] euterium | Dz-Ar | Dz-Ar | Ox-Ar High | | |
| Sources | Lamp | Diffusion | Arc | Voltage | Radio- | Radio- |
| | | | Discharge | Arc Discharge | isotope | isotope |
| Key Aspects | D-Orbital | D-Orbital | Plus | Plus | Plus | Plus |
| for Catalytic | Electrons | Electrons | Electrons | Electrons | Electrons | Electrons |
| Interaction | on | on | on | on Intrabands | on Intrabands | on Intrabands |
| | Outermost | Outer/Inner | Inner | (bound-to- | (bound-to- | (bound-to- |
| | Shell | shells | Shells | free) | free & free- | free & free- |
| | | | | | to-free) | to-free) |
| [symbol] atalytic | Better with | Better with | [symbol] ter with | [symbol] ter with | [symbol] ter with | [symbol] ter with |
| Effects | Transition | Transition | Any Metals | Any Metals | Any Metals | Any Metals |
| (w/o PGM) | Metals | | | | | |
| Lifetime | Mega | Mega | Kilo | Kilo | 30 yrs CW | Syrs CW |
| | Cycles | Cycles | Cycles | Cycles | | |

[symbol]

indicates data missing or illegible when filed

Table II lists the candidate radioisotopes that can be used for NTAC-integrated PEEC device.

TABLE II
Radioisotopes for PEEC Applications.

| | | | p₁ y- | Photon | |
|---|---|---|---|---|---|
| | | | Photon | Emission | Photon |
| r-Ray | | Half-Life | Energy | Rate | Power |
| Source | Production | (year) | (MeV) | (′-//g-s) | (W/g) |
| Cs-137 | Nuclear waste | 30.17 | 0.6617 | 3.215 × 10¹² | 0.34 |
| | (6%) | | | (ref. 12) | |
| Sr-90 | Nuclear waste | 28.79 | 2.826 | 5.21 × 10¹² | 2.36 |
| | (4.505%) | | | (ref. 15) | |
| Co-60 | Artificial | 5.27 | 2.5057 | 4.4 × 10¹³ | 17.66 |
| | | | | (ref. 13) | |
| Na-22 | Artificial | 2.61 | 1.7860 | 2.31 × 10¹⁴ | 66.093 |
| | | | | (ref. 14) | |

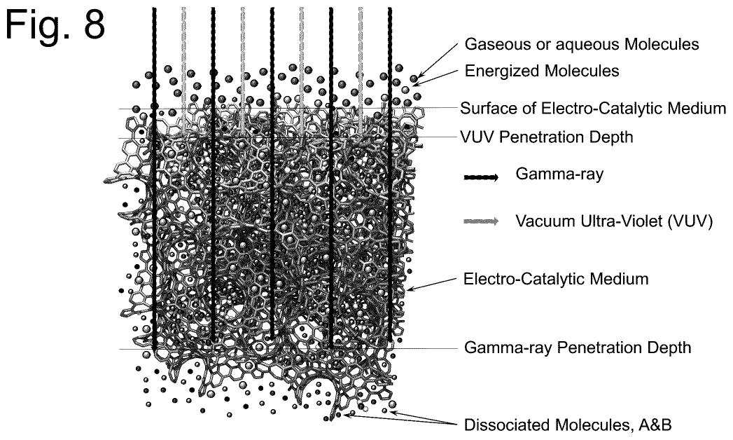

The X-ray and gamma-ray have much higher impacts than the vacuum ultraviolet (VUV) and soft X-ray lights do. The energy and frequency of gamma-rays are sufficiently high that it can dissociate the aqueous or gaseous molecules and ionize the atoms and molecules. Also it can penetrate the electro catalytic material (ECM) much deeper than VUV. FIG. 8 depicts the penetration depth of gamma ray, X-ray, and soft X-rays through the ECM. Along the deep penetration depth of high energy photons, i.e. soft X-rays, X-rays, and gamma rays, through the ECM, the ECM is energized and activated for accelerated catalytic effects on the reaction process of gaseous or aqueous molecules because of scattering to yield and liberate the electrons in intra-band of atoms.

For X-ray and gamma ray, the penetration depths are quite larger than that of soft X-ray as described in FIG. 8. Hence, the catalytic benefit might also increase along with the coupling rate to increase surface energy of ECM through the penetration depth and a priori dissociation and ionization by penetrated energetic electrons and high energy photons. For X-rays and gamma rays, the ECM thickness can be increased because of long penetration depths.

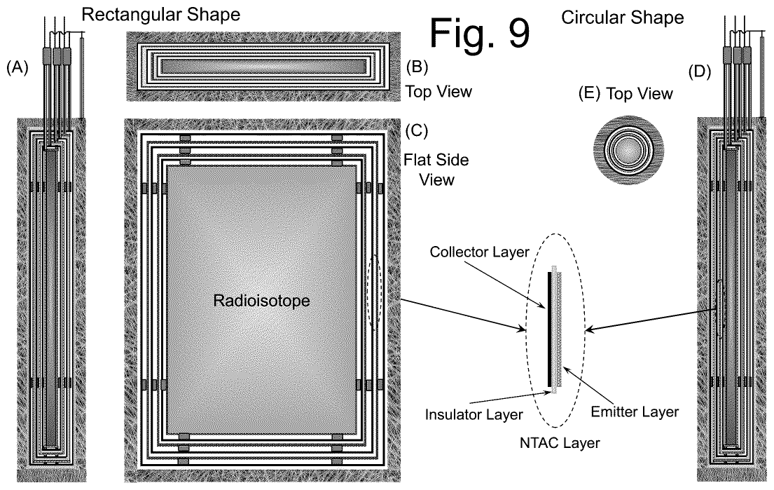

FIG. 9 shows the nano-structured porous foamy electro-catalytic medium (ECM) that encapsulates the NTAC as photon sources in the middle. For this invention, the photon sources are listed in Tables I and II. Photon sources such as Cs-137 or Co-60 are encapsulated in a NTAC. The outer surface of a NTAC is wrapped around by nano-structured catalytic material to make either a cathode or an anode. Because of hazardous radiation from radioisotope, a NTAC is fabricated through an autonomous automated process. The biggest benefits to use radioisotopes as high energy photon source for catalytic process are two folds: The one is the long-term operation by the long half-life of radioisotopes which do not require frequent replacement of PEEC cathode. The other is the drastically enhanced catalytic effect for exothermic or endothermic process of disintegration or synthetic process of gaseous or aqueous materials. With impinging high energy photons, X-ray, and gamma ray, the catalytic process through nano-structured porous foamy ECM can be accelerated by the fact that the increased field potential by supplant electrons in the vicinity of catalytic medium surface surpasses and alleviates the overvoltage issue. The penetration depth is determined by the photon energy and the nature of selected catalytic medium. The deeper the penetration is, the more rate of processable quantity of chemical is. For Cs-137 emission (660 keV), it can penetrate several 10s of centimeters (cm) deep through the nano-structure electro catalytic medium. Accordingly, such high energy photon sources are very useful for mass dissociation or synthetic process required systems. As mentioned above, the NTAC system is completely sealed and shielded by its own structure that keeps and contains radiation from potential leak.

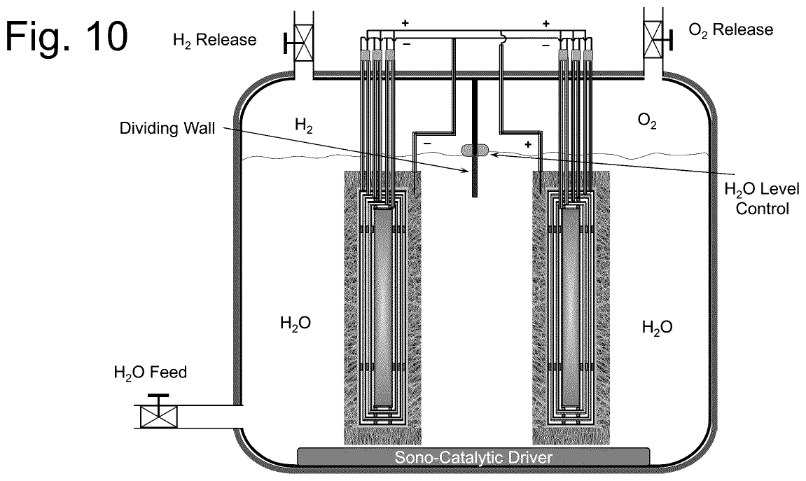

FIG. 10 shows a conceptual description of the invented NTAC-integrated PEEC reactor chamber model. The prime purpose of sono-catalytic driver is to clean and refresh the nano-scale mesh structure of ECM. However, the frequency of sono-catalytic driver is high enough, the nano-scale body of ECM can be coupled with the acoustic wave from sono-catalytic driver. When the resonant frequency of nano-scale ECM couples with the frequency of acoustic wave, it creates a Bragg scattering field that can oscillate both the nano-scale strings of ECM and gaseous or aqueous medium. In this regard, the Bragg field energy can actually promote fast catalytic reaction by increasing the collision frequency of gaseous or aqueous molecules to the surface of already energized ECM electrodes by high energy photons. If the Bragg field energy is exceedingly higher than the binding energy of gaseous or aqueous medium in its vicinity, the sono-catalytic reaction takes place alone literally to dissociate molecules.

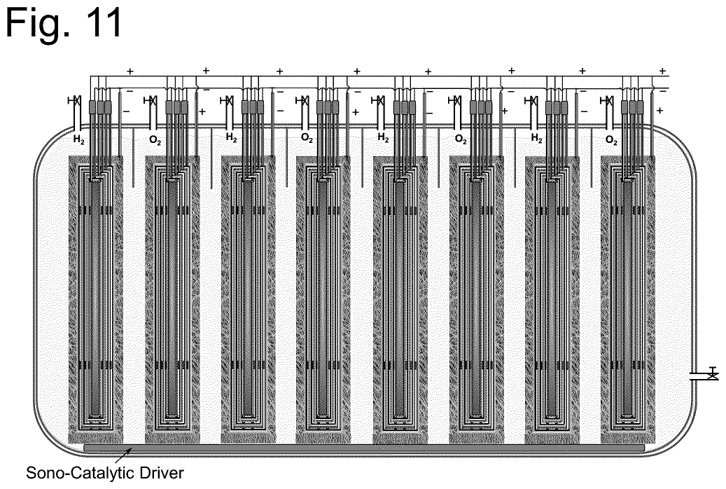

FIG. 11 shows the invented multi-cell NTAC-integrated PEEC reactor. This multi-cell unit has the sono-catalytic driver for cleaning and refreshing the nano-scale strings of ECM electrode. Since the NTAC units within this multi-cell unit generate and supply electrical power directly for its own consumption, no power from the external source is required. By combining the several physical aspects together claimed in the invention, such as (1) the nano-scale strings of ECM domain that has intrinsically high surface energy, (2) the high potential field energy developed within or in the vicinity of nano-scale ECM domain by the avalanche electrons liberated from the intra-band of atoms under the incident high energy photons that even gives rise to much higher surface energy, yielding much higher stress that exceeds the bonding energy of chemicals, (3) the radiolysis effect by the remainder of high energy photons after the NTAC process that adds up further dissociation, (4) the sono-catalysis that has a prime role to clean and refresh the nano-scale strings of ECM potentially vulnerable to contamination, (5) the Bragg field energy by scattering between the frequency of acoustic wave and natural resonant frequency of nano-scale strings of ECM domain that oscillate both the nano-scale strings of ECM and gaseous or aqueous medium to increase the collisional interactions, (6) the sono-catalysis that will take place when the wave energy is high, (7) the power from NTAC that is sufficient to power the PEEC process, and (8) the design of NTAC-integrated PEEC system that uses up all the radiation energy for catalytic process without allowing any leakage.

In chemical reaction processes, catalysts play a crucial role in lowering the kinetic barrier. The dissociation of water molecule into hydrogen and oxygen requires a bipolar catalytic medium as well. The PGMs based on noble metals (Pt, Rh, Pd, Ru, Ir, and Os) have been used as the most efficient hydrogen evolution reaction (HER) electrocatalyst in acid medium owing to its moderate hydrogen binding energy and long-life cycle. On the other hand, noble metal oxides, such as RuO2 and IrO2, are considered as the state-of-the-art electrocatalysts for oxygen evolution reaction (OER). However, the high cost and scarcity of noble metals and power consumption have slowed large-scale applications. And there are no rooms to enhance the performance of noble metals as electrocatalysts further, except for modest improvement [16]. It has been a persisting reason to search around for any alternates. On the other hand, alkaline liquid electrolyzer technology has been commercially used because of the overall low cost of various components. Whereas the activity of Pt in alkaline electrolysis condition is about two to three orders of magnitude lower than that in acid [17]. Significant steps have made in early studies to describe the hydrogen evolution reaction (HER) in alkaline media. The fist-step is the water dissociation as H2O+e−-H*+OH−, where H* represents adsorbed Hon active site, then followed by either Tafel step (2H* —H2) or Heyrovsky step (H2O+H*+e−-H2+H−) [18,19].

In efforts to reduce the cost by improving HER electroactivity, platinum alloys with transition metals were used and it was discovered that Pt alloys with transition metal can have similar synergistic effect of Pt for HER electroactivity. Thus, the development of highly efficient and stable electrocatalysts that bring down water dissociation barrier as low as possible and keep appropriate hydrogen adsorption/desorption strength is highly essential in industrial applications. The goethite Fe+3O(OH) catalyst lowers the activation energy barrier from 5.15 eV to 1.06 eV per H—OH bond [20]. It is known that the performance of a catalyst for the electrocatalytic water splitting is determined by several key parameters for activity, stability, and efficiency. The activity is characterized by the overpotential, Tafel slope, and exchange current density, which can be extracted from the polarization curves as shown in FIG. 19.

The water dissociation rate mainly depends on the efficiency of junctional catalysts [21]. Highly effective catalysts are in demand to minimize the overpotentials for oxygen evolution reaction (OER) and hydrogen evolution reaction (HER) at cathode for efficient production of H2 and 02 [22]. For electrochemical water splitting reaction, the thermodynamic potential is 1.23 Vat 25° C. and 1 atm [23]. However, due to the kinetic barrier for the reaction, water electrolysis requires a higher potential than thermodynamic potential (1.23 V) to overcome the kinetic barrier. The excess potential is also known as overpotential (ri) which mainly comes from the intrinsic activation barriers present on both anode and cathode. Overpotential is a very important descriptor to evaluate the activity of the electrocatalysts. Usually, the overpotential value corresponding to the current density of 10 mA/cm2 is used to compare the activities among different catalysts. This current density corresponds to a 12.3% solar-to-hydrogen efficiency.

The Tafel slope and exchange current are two other parameters to assess the activity from the overpotential vs. kinetic current relationship, which is expressed by the equation: ri=a+ blog j, where ri is the overpotential, and j is the current density [23]. In the Tafel plot, the linear correlation yields two important kinetic parameters. One is the Tafel slope b, and the other is the exchange current density jO which can be obtained by extracting the current at zero overpotential. The Tafel slope bis related to the catalytic reaction mechanism in terms of electron-transfer kinetics. For example, a smaller Tafel slope means that there is a significant current density increment as a function of the overpotential change, or in other words, faster electrocatalytic reaction kinetics. The exchange current density describes the intrinsic charge transfer under equilibrium conditions. A higher exchange current density means a greater charge transfer rate and a lower reaction barrier. A lower Tafel slope and a higher exchange current density are expected for a better electrocatalyst.

Most effective catalytic materials, no matter whether they can work on catalytic process directly or electro-assisted or photo-assisted way, are in demand for many applications. This invention comes with a new approach called the NTAC-integrated PEEC (PEEC-NTAC) for better catalytic effect to answer to various demands. There are several unique features of PEEC-NTAC that set its performance superior to the conventional electrocatalytic media. The photon source for PEEC-NTAC listed in Table II is imbedded inside nano-structured ECM (see FIGS. 1˜4, 9˜11), the photon energy is extremely high (10 eV˜1.33 MeV) that it has a series of coupling interaction with the atoms of nano-structured ECM to liberate a large number of the intra-band electrons of atom. These many numbers of liberated free electrons still carry high energy aftermath of interactions. These electrons have a significant role to diminish or suppress the overpotentials at both HER and OER by electron-transfer kinetics, resulting in faster electrocatalytic reaction kinetics. Energetic photon-interaction induces and results in many free electrons that will increase charge potential at the surface of ECM for greater dissociation rate. The increased charge potential at the surface of ECM exceeds not only kinetic barrier (5.15 V), but also thermodynamic potential (1.23 V) by the charge potential attribution of accumulated number of free electrons at surface layer of ECM over several factor or order of magnitude to split a water molecule. Those free electrons still carrying high kinetic energy with great mobility in ECM domain play substantial role for dramatic increase in not only the charge potential to induce enhanced catalytic reaction mechanism under electron-transfer kinetics, but also exchange current density which lowers reaction barrier. High exchange current density enhances charge transfer rate by even over the required charge density to nearly diminish and nullify the overpotential issues at HER and/or OER.

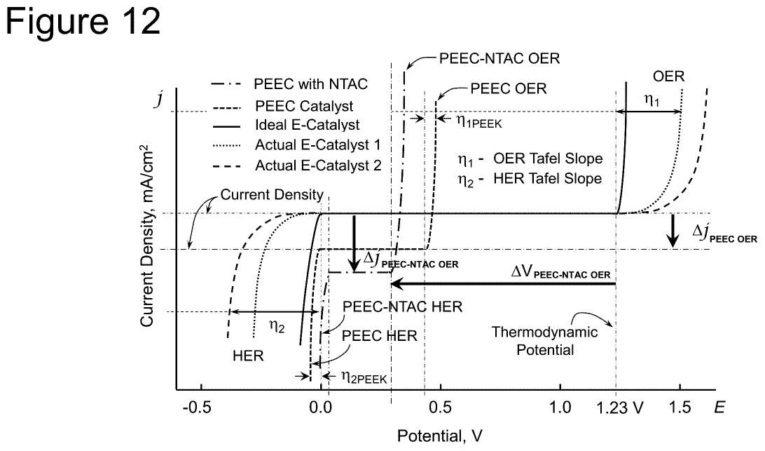

In FIG. 12, the shifts in current density, j PEEC-NTAC, and breakdown potential, VPEEC-NTAC, are the clear indication of advantageous effects by many numbers of liberated free electrons at the surface of nano-structured ECM through coupling process of energetic photons with ECM, even as compared to PEEC OER.

Another aspect of energetic photons is direct coupling with water molecules that can eventually break down water molecules into hydrogen and oxygen through radiolysis process but not by catalytic effect. Since higher the photon energy is, longer the mean free path is, thick ECM for anode and cathode can be used. Since thick ECM increases its volume and reaction surface area, an increased production rate of hydrogen and oxygen is anticipated. FIG. 12 shows summarily the advantageous aspects of PEEC-NTAC.

NTAC Power Generation: The NTAC is designed to use a 60%˜70% level of the photon power for generating electricity that will be used to operate the PEEC-NTAC system and the remainder a 30%-40% for enhancing the surface energy of nano-structured ECM electrode. Table III shows the power generation from each NTAC unit that is integrated into the ECM electrode. The power generation was estimated for the given size of radioisotope (in this case, Co-60) core of NTAC unit.

Materials for PEEC Cathode and Anode: There are virtually no limits on the selection of materials for the cathode and anode of PEEC since abundant energetic electrons liberated from the intra-band of atoms in ECM by the energetic photon source imbedded as a core of NTAC.

The cathode and/or anode can surpass the thermodynamic potential (1.23 V) and intrinsic kinetic barrier potential (5.15 V) for accelerating electrocatalytic reaction kinetics and increase the exchange current density which lowers reaction barrier. It is generally known that a good catalyst would facilitate the adsorption of reactants on the surface of catalyst, their reaction, and desorption of the products to regenerate the active sites for the cyclic process of adsorption-reaction-desorption with new reactant molecules. In terms of common understanding on catalytic process and materials, the characteristics of PEEC-NTAC clearly show extraordinary approach that is advantageous and supersedes the performances of conventional processes and renders a broad option for the selections of materials for cathode and anode. As long as the selected materials for PEEC-NTAC are chemically most resistant against corrosion and oxidation, they will satisfy the material requirements of PEEC-NTAC.

The most of studies for electrocatalytic processes had done to date have focused on active catalytic metals using noble and transition metals for low temperature water-gas shift catalysis [24].

### REFERENCES

[1] S. H. Choi and R. W. Moses, “Photo-Enhanced Electro-Catalytic (PEEC) Process”, U.S. Patent Application Publication No. US 2022/0307144 A1, on Sep. 29, 2022.
[2] S. H. Choi and K. Lee, “Nuclear Thermionic Avalanche Cells with Thermoelectric (NTAC-15 TE) Generator in Tandem Mode”, U.S. Pat. No. 10,269,463, Apr. 23, 2019.
[3] S. Le Caer, “Water Radiolysis: Influence of Oxide Surfaces on H2 Production under Ionizing Radiation”, Water, Vol. 3, No. 1, pp. 235-253, 2011. https://doi.org/10.3390/w3010235
[4] M. B. Gawande, V. D. B. Bonifacio, R. Luque, P. S. Branco, and R. S. Varma, “Solvent-free and Catalysts-free Chemistry: a Benign Pathway to Sustainability”, Chemsuschem 7:24-44, 2014.
[5] T. J. Mason, “Ultrasound in synthetic organic chemistry”, Chem Soc Rev 26: pp. 443-451, 1997.
[6] N. H. Ince and A. Ziylan, “Single and Hybrid Applications of Ultrasound for Decolorization and Degradation of Textile Dye Residuals in Water”, S. K. Sharma (ed), Green chemistry for dyes removal from waste water, Wiley, Hoboken, NJ, USA, pp 261-263, 2015.
[7] K. S. Suslick, “Sonoluminescence and Sonochemistry”, In: IEEE Ultrason. Symp, Proceedings. An Int. Symp. (Cat. No. 97CH36118), 1997. 1. doi: 10.1109/ULTSYM.1997.663076
[8] K. S. Suslick and S. Skrabalak, “Sonocatalysis”, In: Ertl G, Knozinger H, Schuth F, Weitkamp J (eds), Handbook of Heterogeneous Catalysis, 2nd ed. Wiley-VCH, Weinheim, pp 2006-2017, 2008.
[9] J. L. Lache, “Synthetic Organic Sonochemistry”, 1st ed. Springer, US, New-York, pp. 246-250, 2013.
[10] Z. Chen, J. J. Concepcion, M. K. Brennaman, P. Kang, M. R. Norris, P. G. Hoertz, and T. J. Meyer, “Splitting CO2 into CO and 02 by a single catalyst”, PNAS, vol. 109, no. 39, 15606-15611, Sep. 25, 2012,
[11] https://www.researchgate.net/figure/A-spectrum-obtained-from-a-Cs-137-gamma ray-15 source-using-a-1-cm-3-coplanar-grid-CdZnTe_fig1_3914309
[12] “NIST Nuclide Half-Life Measurements”. NIST. Retrieved 13 Mar. 2011.
[13] https://en.wikipedia.org/wiki/Cobalt-60
[14] 6244 Ci/g=2.31x1014 Bq/g.s http://ehs.umich.edu/wpcontent/uploads/sites/37/2016/04/Sodium-22.pdf
[15] Delacroix, D.; Guerre, J. P.; Leblanc, P.; Hickman, C. “Radionuclide and Radiation Protection Data Handbook 2002”, 2nd ed., Nuclear Technology Publishing. ISBN 978-1-870965-87-3.
[16] C. Hu, L. Zhang, J. Gong, Energy Environ. Sci. 12(9), 2620-2645 (2019).
[17] P. J. Rheinlander, J. Herranz, J. Durst, and H. A. Gasteiger, J. Electrochem. Soc.2014, 161,F1448.
[18] R. Subbaraman et al., “Trends in activity for the water electrolyser reactions on 3d M (Ni,Co,Fe,Mn)hydr(oxy)oxide catalysts”, Nature Materials, Vol. 11, Issue 6, May 6, 2012, pp. 550-557.
[19] D. Strmonik, P. P. Lopes, B. Genorio, V. R. Stamenkovic, N. M. Markovic, “Design principles for hydrogen evolution reaction catalyst materials”, Nano Energy, Vol. 29, November 2016, pp. 29-36.
[20] M. A. Shehzad, et al., “Shielded goethite catalyst that enables fast water dissociation in bipolar membranes”, Nature Communications, Vol. 12, Article number: 9 (2021)
[21] Z. F. Yan, et al. “The balance of electric field and interfacial catalysis in promoting water dissociation in bipolar membranes”. Energy Environ. Sci. 11, 2235-2245 (2018).
[22] N.-T. Suen, S.-F. Hung, Q. Quan, N. Zhang, Y.-J Xu, H. M.: Chen, Chem. Soc. Rev. 46 (2), 337-365 (2017),
[23] S. Wang, A. Lu and C.-J. Zhong, “Hydrogen production from water electrolysis: role of catalysts”, Review paper, Nano Convergence, Vol. 8, Issue 4, Feb. 11, 2021.
[24] P. Ebrahimi, A. Kumar, and M. Khraishch, “A review of recent advances in water-gas shift catalysis for hydrogen production”, Emergent Materials, Vol. 3, 2020, pp. 881-917.

What is claimed is:

1. A photo-enhanced electro-catalytic structure comprising electrode configurations for photo-enhanced elecro-catalytic reactions that interacts with a secondary structure creating a further interaction creating a cascade of electro-catalytic interactions.

2. The invention of claim 1, wherein the electro-catalytic structure comprises a radiation source that provides gamma-ray photons and/or energetic beta-particles are emitted that interact with a secondary structure;

3. The invention of claim 2 wherein the interaction with the secondary structure induces the creation of emissions in the secondary structure that induce energetic energy transmissions resulting from the interactions,

4. The secondary structure of claim 2 wherein the secondary structure provides an avalanche effect to additional structures that provide a cascading structure of additional reactions that multiply the interactions.
